(19) United States
(12) Patent Application Publication
(10) Pub. No.: US 2021/0370877 A1
(43) Pub. Date: Dec. 2, 2021

(54) VEHICULAR ACCESS SYSTEM USING NFC READER IN DOOR HANDLE

(71) Applicant: Magna Mirrors of America, Inc., Holland, MI (US)

(72) Inventor: Eric Peterson, West Olive, MI (US)

(21) Appl. No.: 17/303,362

(22) Filed: May 27, 2021

Related U.S. Application Data
(60) Provisional application No. 62/704,773, filed on May 28, 2020.

(51) Int. Cl. B60R 25/24; B60R 25/01; B60R 16/023; H04L 9/32; H04B 5/00

(52) U.S. Cl. CPC B60R 25/246; B60R 25/01; B60R 16/023; H04L 9/3271; H04L 2209/805; H04B 5/0031; B60R 2325/103; H04L 2209/84; H04B 5/0056

(57) ABSTRACT

A vehicular exterior door handle assembly includes a handle portion disposed at an exterior side of a door of a vehicle, and a printed circuit board (PCB) disposed at the handle portion. The PCB includes a near-field communication (NFC) reader that includes a microcontroller and an antenna. The antenna emits a magnetic field. The NFC reader detects disturbances in the emitted magnetic field. The NFC reader, responsive to detecting a disturbance in the emitted magnetic field from an NFC tag, adjusts operation of the NFC reader from a power-saving state of operation to an active state of operation. The NFC reader, when operating in the active state, wirelessly communicates an authentication signal to the NFC tag. The NFC reader, responsive to receiving a valid authentication response from the NFC tag, unlocks a door of the vehicle.

### CROSS REFERENCE TO RELATED APPLICATION

The present application claims the filing benefits of U.S. provisional application Ser. No. 62/704,773, filed May 28, 2020, which is hereby incorporated herein by reference in its entirety.

### FIELD OF THE INVENTION

The present invention relates to door handles for vehicles and, more particularly, an exterior door handle for opening a side door of a vehicle responsive to a passive entry device or system.

### BACKGROUND OF THE INVENTION

A door handle for a vehicle door typically includes a handle portion that is pivotable relative to a base portion, whereby pivotal movement of the handle portion pulls at a cable or rod or mechanism to electrically and/or mechanically trigger or move a latch mechanism to release the latch and open the door.

### SUMMARY OF THE INVENTION

The present invention provides a door handle assembly configured to mount at a handle region of a vehicle door. The door handle assembly comprises a handle portion mounted at the handle region of the vehicle door. The door handle assembly includes a printed circuit board (PCB) disposed at the handle portion and including a near-field communication (NFC) reader that includes a microcontroller and an antenna. The antenna, with the NFC tag operating in a power-saving state of operation, emits a magnetic field. The NFC reader detects disturbances in the magnetic field from an NFC tag present external of the vehicle and proximate to the door of the vehicle. The NFC reader, responsive to the NFC reader detecting a disturbance in the emitted magnetic field from the NFC tag, adjusts operation of the NFC reader from the power-saving state of operation to an active state of operation. The NFC reader, when operating in the active state of operation, wirelessly communicates with the NFC tag. The NFC reader wirelessly communicates with the NFC tag by wirelessly communicating an authentication signal to the NFC tag and wirelessly receiving an authentication response signal from the NFC tag. The NFC reader, responsive to wirelessly receiving the authentication response signal from the NFC tag, determines whether the received authentication response signal is a valid authentication response signal. The NFC reader, responsive to determining the received authentication response signal is valid, unlocks the door of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a door handle assembly of the present invention;

FIG. 2 is a schematic view of a sequence diagram in accordance with the present invention;

FIG. 3 is a schematic view of a block diagram of the door handle assembly; and

FIG. 4 is a perspective view of a circuit board of the door handle assembly.

### DESCRIPTION OF THE PREFERRED EMBODIMENTS

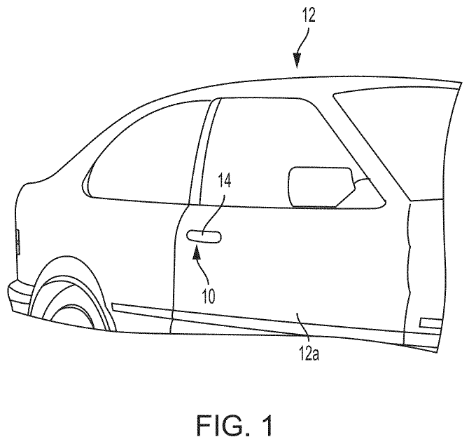

Referring now to the drawings and the illustrative embodiments depicted therein, a vehicle door handle assembly 10 is mountable to a door 12a of a vehicle 12 and operable to release a latch mechanism of the door 12a to open the vehicle door (FIG. 1). The vehicle door handle assembly 10 includes a handle portion 14 that is disposed at the door and that is fixedly mounted at the door or to a bracket mounted to the door. The handle portion may be movably mounted at the handle region of the vehicle door (such as pivotally mounted), whereby movement of the handle portion by a user opens the vehicle door.

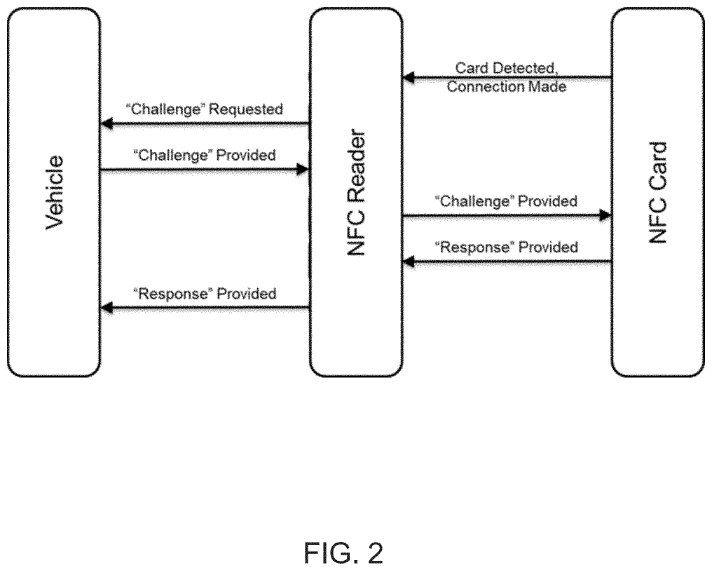

Referring now to FIG. 2, the door handle assembly includes a near-field communication (NFC) reader integrated circuit (IC). The NFC reader IC is disposed on a printed circuit board (PCB) that includes a processor or microcontroller and an antenna (e.g., a loop antenna). The microcontroller comprises circuitry and associated software, with the circuitry comprising a processor for processing signals or data or output received from the antenna. Electric current flows through the antenna to generate a magnetic field (e.g., an inductive field) near the vicinity of the door handle assembly. The NFC reader is configured to communicate (via NFC) with an NFC tag. The tag may be included in or on any device, such as a card, a user device (e.g., a mobile phone), a key fob, etc. Although shown and described as being disposed at or incorporated in an exterior door handle assembly at a side door of the vehicle, the NFC reader may be disposed elsewhere at the vehicle, such as at or in the door of the vehicle or at or in an exterior rearview mirror mounted at the side of the vehicle.

Optionally, the microcontroller remains in a passive or sleep state until woken by the NFC reader. A NFC tag disturbs the magnetic field when in close proximity to the door handle assembly. The magnetic field energizes the NFC tag (i.e., provides the power necessary for the NFC tag to communicate with the NFC reader and/or microcontroller). The NFC reader may monitor for disturbances in the magnetic field generated from the antenna, and in response to a disturbance (e.g., the NFC tag entering the proximity of the door handle assembly), wake the microcontroller such that the microcontroller enters an active state from a sleep state. In the active state, the microcontroller communicates with the NFC tag.

Thus, the NFC reader IC is able to detect the presence of an NFC tag by monitoring the inductive field generated by the antenna, which saves on power and prevents flooding the immediate area near the door handle assembly with radio frequency (RF). The antenna may comprise any suitable construction for NFC type communication (i.e., generating a magnetic field), such as an inside-to-outside coil construction or a “symmetric” antenna layout of alternating or interleaved segments, where a symmetric layout provides a more uniform field. Optionally, the NFC IC includes a capacitor bank, which allows for live tuning of the antenna frequency to compensate for changes in the environment. For example, the capacitor bank may tune the antenna frequency responsive to the NFC reader being in the vicinity of sheet metal, mobile phones, cards, or other items that may interfere with the magnetic field. The NFC reader generates the magnetic field via an NFC antenna disposed on the PCB. When an NFC tag is detected by the NFC reader, the NFC reader wakes up the microcontroller, and the system initiates communication with the NFC tag.

Once, the system initiates communication with the NFC tag, the system may communicate with a controller at the vehicle to perform an authentication process to determine that the NFC tag is authorized to enable operation of a function of the vehicle (e.g., unlock the door). For example, after a valid NFC tag is detected and a connection is established between the NFC card and the NFC reader, the microcontroller signals the vehicle that a tag has been found, and requests from the vehicle (i.e., a control or ECU of the vehicle) an authentication signal (e.g., a cryptographic challenge). The NFC reader and the vehicle controller may communicate over a variety of protocols such as Local Interconnect Network (LIN), Controller Area Network (CAN), Controller Area Network Flexible Data (CAN-FD), or any other suitable communication protocol. The vehicle controller responds with a challenge and the microcontroller/NFC reader passes the challenge on to the NFC tag. The NFC tag responds with an authentication response (e.g., a cryptographic response) that the microcontroller returns to the vehicle controller. The cryptographic response authenticates the NFC tag as an authorized tag. In response to authenticating the NFC tag, the ECU or vehicle control allows access to the vehicle or to a feature of the vehicle (e.g., unlocks the door).

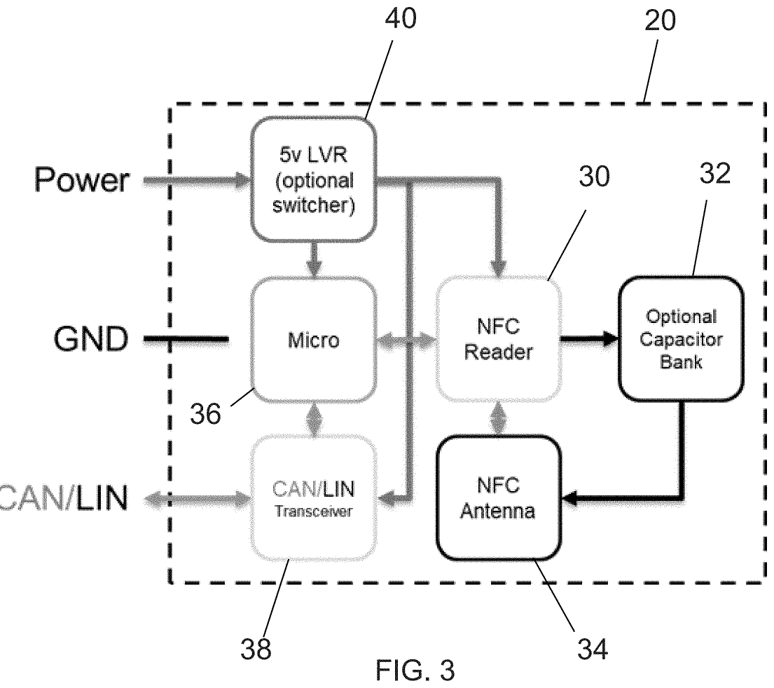

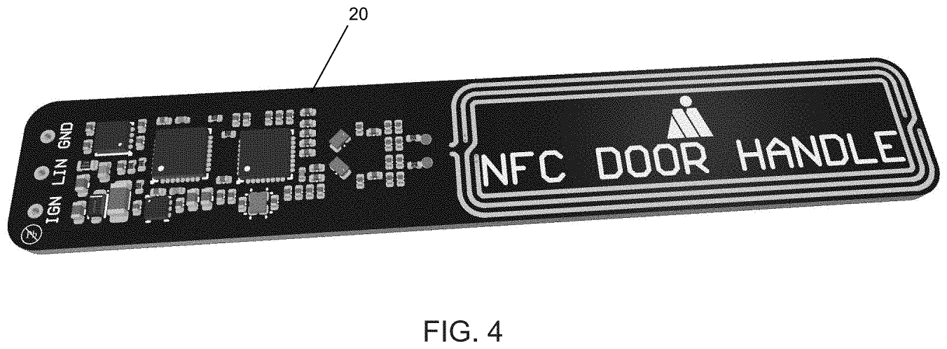

Referring now to FIGS. 3 and 4, the door handle assembly includes the PCB 20 (FIGS. 3 and 4) with the NFC reader 30. The NFC reader 30 may include an optional capacitor bank 32. The NFC reader 30 detects the NFC tag using the NFC antenna 34 (i.e., the loop antenna) and communicates with the microcontroller 36. The microcontroller communicates with the vehicle controller via the transceiver 38. The microcontroller 36, transceiver 38, and NFC reader 30 may be powered by a 5V low voltage regulator (LVR) 40 with an optional switcher.

Thus, optionally, the NFC reader/microcontroller does not provide any encryption/decryption or decision making and instead is simply a “man-in-the-middle” system that provides communication between the vehicle controller and the NFC tag carried by the operator. In other words, encryption/decryption (or any other suitable means of authenticating a user's ability to access the vehicle) may be performed by additional systems of the vehicle and the NFC reader provides a communication medium for such systems. Thus, all authentication and encryption/decryption may instead occur elsewhere within the vehicle control systems.

Optionally, the door handle assembly may include sensing techniques to detect presence of the user's hand near the door handle assembly or in the pocket region of the door handle assembly. For example, the door handle assembly may provide capacitive sensing, SURETOUCH™ sensing, pressure (i.e., piezoelectric) sensing, inductive sensing, or the like, and/or may provide for mechanical actuation of the door latch mechanism by the user's hand in the pocket region.

The door handle assembly may comprise any suitable type of door handle assembly, and may include or incorporate aspects of the door handle assemblies described in U.S. Pat. Nos. 6,349,450; 6,550,103; 6,907,643; 7,407,203; 8,333,492; 8,786,401; 8,801,245 and/or 9,290,970, and/or U.S. Publication Nos. US-2020-0130646; US-2020-0122631; US-2019-0106051; US-2010-0088855 and/or US-2010-0007463, which are hereby incorporated herein by reference in their entireties. Although shown as a strap type handle, the handle assembly may comprise any suitable type of vehicle door handle assembly, such as a paddle type vehicle door handle assembly (having a paddle or the like that may be pulled at to open the vehicle door) or other type of vehicle door handle assembly, while remaining within the spirit and scope of the present invention.

Optionally, the door handle assembly may comprise a flush door handle assembly (such as of the types described in U.S. Pat. No. 8,786,401 and/or U.S. Publication No. US-2020-0102773, which are hereby incorporated herein by reference in their entireties), whereby the lighting and sensing module may actuate to illuminate the handle portion and may also emit light through the handle portion or around the handle portion. Optionally, the door handle assembly of the present invention may include a soft touch handle portion, such as utilizing the principles described in U.S. Pat. Nos. 6,349,450; 6,550,103 and/or 6,907,643, which are hereby incorporated herein by reference in their entireties

Optionally, the door handle assembly may include or may be associated with an antenna for receiving signals from or communicating with a remote device. For example, the antenna (such as, for example, an antenna of the types described in U.S. Pat. Nos. 9,484,626 and/or 6,977,619, which are hereby incorporated herein by reference in their entireties) may communicate a signal to the door locking system via a wire connection or the like, or wirelessly, such as via a radio frequency signal or via an infrared signal or via other wireless signaling means. Such connections can include cables, wires, fiber optic cables or the like. The communication to the locking system may be via a vehicle bus or multiplex system, such as a LIN (Local Interconnect Network) or CAN (Car or Controlled Area Network) system, such as described in U.S. Pat. Nos. 6,291,905; 6,396,408 and/or 6,477,464, which are all hereby incorporated herein by reference in their entireties. The vehicle door may then be unlocked and/or the illumination source or sources may be activated as a person carrying a remote signaling device approaches the door handle. Optionally, other systems may be activated in response to the remote signaling device, such as vehicle lighting systems, such as interior lights, security lights or the like (such as security lights of the types disclosed in U.S. Pat. Nos. 8,764,256; 6,280,069; 6,276,821; 6,176,602; 6,152,590; 6,149,287; 6,139,172; 6,086,229; 5,938,321; 5,671,996; 5,497,305; 6,416,208 and/or 6,568,839, and/or U.S. Publication No. US-2013-0242586, all of which are hereby incorporated herein by reference in their entireties), or the vehicle ignition, or any other desired system, while remaining within the spirit and scope of the present invention. The door handle and/or illumination module may be in communication with other systems and/or controls of the vehicle door and/or vehicle, such as by utilizing aspects of the door systems described in U.S. Publication No. US-2010-0007463, which is hereby incorporated herein by reference in its entirety.

Optionally, the lighting and sensing module may comprise a strip light or pocket light or the like, and the door handle assembly may include a ground illumination light and/or other light or lighting element, such as a projection light or the like, such as by utilizing aspects of the door handle assemblies and lighting systems described in U.S. Pat. Nos. 5,371,659; 5,497,305; 5,669,699; 5,823,654; 6,349,450; 6,550,103; 8,786,401 and/or 8,801,245, and/or U.S. Publication Nos. US-2010-0088855 and/or US-2010-0007463, which are hereby incorporated herein by reference in their entireties.

Changes and modifications to the specifically described embodiments may be carried out without departing from the principles of the present invention, which is intended to be limited only by the scope of the appended claims as interpreted according to the principles of patent law.

1. A vehicular exterior door handle assembly, the vehicular exterior door handle assembly comprising:
a handle portion disposed at an exterior side of a door of a vehicle;
a printed circuit board (PCB) disposed at the handle portion, the PCB having circuitry disposed thereat, the circuitry comprising a near-field communication (NFC) reader, the NFC reader comprising a microcontroller and an antenna;
wherein, with the NFC reader operating in a power-saving state of operation, the antenna emits a magnetic field;
wherein the NFC reader detects disturbances in the emitted magnetic field from an NFC tag present external of the vehicle and proximate to the door of the vehicle;
wherein the NFC reader, responsive to the NFC reader detecting a disturbance in the emitted magnetic field from the NFC tag, adjusts operation of the NFC reader from the power-saving state of operation to an active state of operation;
wherein the NFC reader, when operating in the active state of operation, wirelessly communicates with the NFC tag;
wherein the NFC reader wirelessly communicates with the NFC tag by wirelessly communicating an authentication signal to the NFC tag and wirelessly receiving an authentication response signal from the NFC tag;
wherein the NFC reader, responsive to wirelessly receiving the authentication response signal from the NFC tag, determines whether the received authentication response signal is a valid authentication response signal; and
wherein the NFC reader, responsive to determining the received authentication response signal is valid, unlocks the door of the vehicle.

2. The vehicular exterior door handle assembly of claim 1, wherein the authentication signal comprises a cryptographic challenge, and wherein the authentication response signal comprises a cryptographic response.

3. The vehicular exterior door handle assembly of claim 2, wherein the NFC reader receives the cryptographic challenge from an electronic control unit (ECU) of the vehicle.

4. The vehicular exterior door handle assembly of claim 3, wherein, responsive to determining the received cryptographic response is valid, the NFC reader communicates the valid cryptographic response to the ECU of the vehicle, and wherein, responsive to receiving the valid cryptographic response, the ECU of the vehicle authenticates the NFC tag, and wherein, responsive to authenticating the NFC tag, the ECU of the vehicle unlocks the door of the vehicle.

5. The vehicular exterior door handle assembly of claim 3, wherein the NFC reader communicates with the ECU of the vehicle via one selected from the group consisting of: (i) Local Interconnect Network (LIN), (ii) Controller Area Network (CAN) and (iii) Controller Area Network Flexible Data (CAN-FD).

6. The vehicular exterior door handle assembly of claim 1, wherein the antenna comprises a loop antenna.

7. The vehicular exterior door handle assembly of claim 1, wherein the antenna comprises a symmetric antenna.

8. The vehicular exterior door handle assembly of claim 1, wherein the NFC reader comprises a capacitor bank.

9. The vehicular exterior door handle assembly of claim 8, wherein, responsive to an environment of the exterior door handle assembly, the capacitor bank tunes a frequency of the magnetic field emitted by the antenna.

10. The vehicular exterior door handle assembly of claim 1, wherein the NFC tag is part of a mobile device.

11. The vehicular exterior door handle assembly of claim 1, wherein the NFC reader comprises an NFC reader integrated circuit (IC).

12. A method for unlocking a door of a vehicle, the method comprising:
providing a vehicular exterior door handle assembly comprising a handle portion disposed at an exterior side of a door of a vehicle;
providing a printed circuit board (PCB) at the handle portion, the PCB comprising a near-field communication (NFC) reader, the NFC reader comprising a microcontroller and an antenna;
while the NFC reader is operating in a power-saving state of operation, emitting, via the antenna, a magnetic field at the exterior side of the door;
detecting, via the NFC reader, a disturbance in the emitted magnetic field from an NFC tag present external of the vehicle and proximate to the side of the vehicle;
responsive to detecting the disturbance in the emitted magnetic field, adjusting operation of the NFC reader from the power-saving state of operation to an active state of operation;
with the NFC reader operating in the active state of operation, wirelessly communicating, via the NFC reader, a cryptographic challenge to the NFC tag; and
responsive to wirelessly receiving a valid cryptographic response from the NFC tag in response to the cryptographic challenge, unlocking the door of the vehicle.

13. The method of claim 12, wherein communicating the cryptographic challenge to the NFC tag comprises wirelessly receiving, at the NFC reader, the cryptographic challenge from an electronic control unit (ECU) of the vehicle.

14. The method of claim 12, wherein the NFC tag is part of a mobile device carried by a user.

15. The method of claim 12, wherein the antenna comprises a loop antenna.

16. The method of claim 15, wherein the antenna comprises a symmetric antenna.

17. A vehicular exterior door handle assembly, the vehicular exterior door handle assembly comprising:
a handle portion disposed at an exterior side of a door of a vehicle;
a printed circuit board (PCB) disposed at the handle portion, the PCB having circuitry disposed thereat, the circuitry comprising a near-field communication (NFC) reader, the NFC reader comprising a microcontroller, an antenna, and an integrated circuit (IC), the IC comprising a capacitor bank;
wherein, with the NFC reader operating in a power-saving state of operation, the antenna emits a magnetic field;
wherein, responsive to an environment of the exterior door handle assembly, the capacitor bank tunes a frequency of the magnetic field emitted by the antenna;
wherein the NFC reader detects disturbances in the emitted magnetic field from an NFC tag present external of the vehicle and proximate to the door of the vehicle;
wherein the NFC reader, responsive to the NFC reader detecting a disturbance in the emitted magnetic field from the NFC tag, adjusts operation of the NFC reader from the power-saving state of operation to an active state of operation;
wherein the NFC reader, when operating in the active state of operation, wirelessly communicates with the NFC tag;
wherein the NFC reader wirelessly communicates with the NFC tag by wirelessly communicating an authentication signal to the NFC tag and wirelessly receiving an authentication response signal from the NFC tag;
wherein the NFC reader, responsive to wirelessly receiving the authentication response signal from the NFC tag, determines whether the received authentication response signal is a valid authentication response signal; and
wherein the NFC reader, responsive to determining the received authentication response signal is valid, unlocks the door of the vehicle.

18. The vehicular exterior door handle assembly of claim 17, wherein the authentication signal comprises a cryptographic challenge, and wherein the authentication response signal comprises a cryptographic response.

19. The vehicular exterior door handle assembly of claim 18, wherein the NFC reader receives the cryptographic challenge from an electronic control unit (ECU) of the vehicle.

20. The vehicular exterior door handle assembly of claim 19, wherein the NFC reader communicates with the ECU of the vehicle via one selected from the group consisting of: (i) Local Interconnect Network (LIN), (ii) Controller Area Network (CAN) and (iii) Controller Area Network Flexible Data (CAN-FD).
